(19) United States
(12) Patent Application Publication
(10) Pub. No.: US 2018/0371887 A1
(43) Pub. Date: Dec. 27, 2018

(54) PLASMA-PULSED HYDRAULIC FRACTURE WITH CARBONACEOUS SLURRY

(71) Applicant: Saudi Arabian Oil Company, Dhahran (SA)

(72) Inventor: Abdulrahman Abdulaziz Al-Mulhem, Dhahran (SA)

(21) Appl. No.: 15/963,322

(22) Filed: Apr. 26, 2018

Related U.S. Application Data
(60) Provisional application No. 62/523,414, filed on Jun. 22, 2017.

(51) Int. Cl. E21B 43/26; E21B 43/00; C09K 8/66; C09K 8/68

(52) U.S. Cl. CPC E21B 43/26; C09K 8/68; C09K 8/665; E21B 43/003

(57) ABSTRACT

Plasma-pulsed hydraulic fracture system with carbonaceous slurry is described. The system includes a hydraulic fluid pumping unit and a plasma pulsing tool. The pumping unit can pump hydraulic fracturing fluid to a downhole location in a wellbore formed in a hydrocarbon reservoir. A hydraulic fracture is to be initiated at the downhole location. The pumping unit can pump the fracturing fluid at a hydraulic fluid pressure sufficient to initiate and propagate the hydraulic fracture from the downhole location into the hydrocarbon reservoir. The plasma pulsing tool is positioned at the downhole location. The tool can generate and transmit a plasma pulse to the downhole location. The plasma pulse can increase the hydraulic fluid pressure of the hydraulic fracturing fluid.

### TECHNICAL FIELD

This disclosure relates to hydraulic fracturing, for example, of hydrocarbon formations to release or provide access to hydrocarbons entrapped within the formations.

### BACKGROUND

Unconventional reservoirs, for example, tight-gas sands, gas and oil shales, coalbed methane, heavy oil and tar sands, gas-hydrate deposits, require special recovery operations outside conventional operating practices. Horizontal wells in these reservoirs are often hydraulically fractured, for example, in many stages, to produce entrapped hydrocarbons. To hydraulically fracture a reservoir (including an unconventional reservoir), a hydraulic fracturing fluid is pumped into the formation at a pressure that exceeds the formation parting pressure or fracturing gradient to break down the formation and propagate a fracture through the formation. The fracturing fluid includes proppants which fill the induced fracture, thereby making those fractures conductive channels.

### SUMMARY

This disclosure relates to plasma-pulsed hydraulic fracturing. This disclosure also relates to using a carbonaceous slurry as the fracturing fluid in the plasma-pulsed hydraulic fracturing.

Certain aspects of the subject matter described here can be implemented as a hydraulic fracturing system. The system includes a hydraulic fluid pumping unit and a plasma pulsing tool. The pumping unit can pump hydraulic fracturing fluid to a downhole location in a wellbore formed in a hydrocarbon reservoir. A hydraulic fracture is to be initiated at the downhole location. The pumping unit can pump the fracturing fluid at a hydraulic fluid pressure sufficient to initiate and propagate the hydraulic fracture from the downhole location into the hydrocarbon reservoir. The plasma pulsing tool is positioned at the downhole location. The tool can generate and transmit a plasma pulse to the downhole location. The plasma pulse can increase the hydraulic fluid pressure of the hydraulic fracturing fluid.

This, and other aspects, can include one or more of the following features. A coiled tubing or a wireline can transport the plasma pulsing tool from a surface of the wellbore to the downhole location. A power source can be connected to the plasma pulsing tool. The power source can provide power to the plasma pulsing tool in response to which the plasma pulsing tool can generate the plasma pulse. The plasma pulsing tool can be configured to generate plasma pulses having energies ranging between 1 kiloJoule (kJ) and 100 kJ, for example, between 1 kJ and 10 kJ. The plasma pulsing tool can withstand a formation pressure of at least 10,000 pounds per square inch (psi). A notching tool can form a notch at the downhole location. The wellbore can include a horizontal wellbore. The hydraulic fracturing fluid can include a particulate portion and a water portion. The water portion can adjust a viscosity of the hydraulic fracturing fluid such that the hydraulic fracturing fluid can be pumped into the hydrocarbon formation and the hydraulic fracturing fluid can fracture the hydrocarbon formation. The particulate portion can include a calcium carbonate component, a cement component, a sand component, a bentonite component, and a solid acid component. The calcium carbonate component can be obtained from a naturally occurring source. The cement component can be Portland cement. The sand component can be a silica based sand. The bentonite component can be selected from the group consisting of potassium bentonite, sodium bentonite, calcium bentonite, aluminum bentonite, and combinations thereof. The solid acid component can be selected from the group consisting of sulfamic acid, chloroacetic acid, carboxylic acid, trichloroacetic acid, and combinations thereof. The particulate portion can be between 20-80% wt. calcium carbonate component, 5-30 percent by weight (% wt.) cement component, 5-30% wt. sand component, 2-10% wt. bentonite component, and 5-30% wt. solid acid component. The particulate portion can be between 30% wt. calcium carbonate component, 25% wt. cement component, 15% wt. sand component, 10% wt. bentonite component, and 20% wt. solid acid component. The hydrocarbon reservoir can be an unconventional reservoir.

Certain aspects of the subject matter described here can be implemented as a hydraulic fracturing method. Hydraulic fracturing fluid is flowed to a downhole location formed in a hydrocarbon reservoir at a hydraulic fluid pressure sufficient to initiate and propagate a hydraulic fracture from the downhole location into the hydrocarbon reservoir. While flowing the hydraulic fracturing fluid to the downhole location, a plasma pulse is generated and transmitted to the downhole location in the wellbore. The plasma pulse increases the hydraulic fluid pressure of the hydraulic fracturing fluid. The hydraulic fracture is generated and propagated at the downhole location based on the increased hydraulic fluid pressure of the hydraulic fracturing fluid.

This, and other aspects, can include one or more of the following features. The plasma pulse can be generated and transmitted by a plasma pulsing tool, which can be positioned at the downhole location. The plasma pulse can be a first plasma pulse. A sequence of plasma pulses, which include the first plasma pulse, can be generated, for example, one pulse after the other, successive pulses separated by a time interval. Each plasma pulse can be transmitted to the hydraulic fluid. The sequence of plasma pulses can be transmitted at the hydraulic fluid at a frequency. A notch can be formed at the downhole location before flowing the hydraulic fracturing fluid or generating and transmitting the plasma pulse.

The details of one or more implementations of the subject matter described in this specification are set forth in the accompanying drawings and the description that follows. Other features, aspects, and advantages of the subject matter will become apparent from the description, the drawings, and the claims.

### BRIEF DESCRIPTION OF THE DRAWINGS

FIG. 1 is schematic diagram of a hydraulic fracturing operation implementing a plasma pulsing tool.

FIG. 2 is a flowchart of an example of a process for hydraulic fracturing of a hydrocarbon reservoir.

FIG. 3 shows the permeability of a slurry-like fracturing fluid from room temperature to resting reservoir temperature.

FIG. 4 shows the reservoir temperature during acid fracturing of a reservoir.

FIG. 5 shows the temperature and flow rate versus time of a slurry-like fracturing fluid.

FIG. 6 shows the permeability of a slurry-like fracturing fluid from room temperature to reservoir temperature.

Like reference numbers and designations in the various drawings indicate like elements.

### DETAILED DESCRIPTION

Oil and gas wells in unconventional, for example, tight reservoirs, are stimulated by hydraulic fracturing. Fracturing operations can be done in open or cased holes, or both. Hydraulic fracturing is carried out using completions that isolate part of the well section, perforate the section (if the well is cased) and pump the fracturing fluid to initiate and propagate the fracture. In some cases, the tight formation (for example reservoir rocks with permeability in the range of microDarcy to nanoDarcy) can have high stress values (stress values in the range of about 10,000 pounds per square inch (psi)) or a rock with very high compressive strength value (for example, compressive strength values in the range of about 10,000 psi) making the breakdown of the rock or fracture propagation (or both) a prohibitive target and rendering the fracturing operation unsuccessful.

This disclosure describes a plasma pulsing tool that can be combined with the hydraulic fluid pumps to increase the fracture pressure applied to the tight formations or high compressive strength rock. This disclosure also describes using a particular type of hydraulic fracturing fluid (for example, a carbonaceous slurry) that transfers pressure from hydraulic pumps to the formation and additionally serves as proppant to keep the fractured formation open.

The combination of plasma pulsing and hydraulic fracturing generates higher pressure compared to pressure generated by plasma pulsing alone or hydraulic fracturing alone. The pulsing can weaken the formation and help the fracturing fluid to initiate and propagate the fracture. Using the carbonaceous slurry as the fracturing fluid avoids a need to remove the fluid from the formation after inducing the fracture. Such use of the slurry also negates a need for a cleaning operation because the slurry can serve as the propping agent of the induced fracture. The propped fracture can be further stimulated if the slurry contains solid acid which when hydrolyzed will provide a stimulating effect of the propped fluid thus making the fracture more conductive to hydrocarbons.

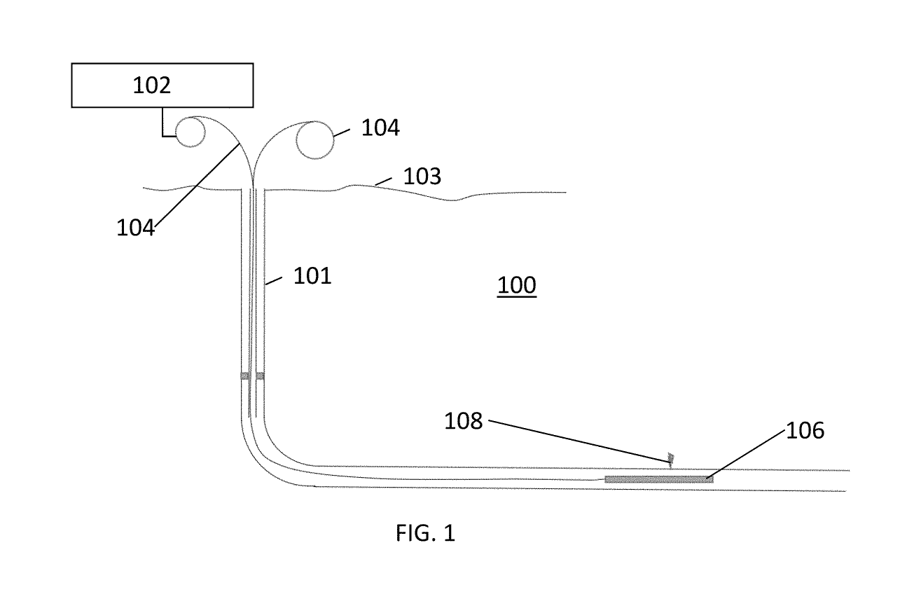

FIG. 1 is schematic diagram of a hydraulic fracturing operation implementing a plasma pulsing tool. In some implementations, the hydraulic fracturing operation is implemented using a hydraulic fluid pumping unit 102 and a plasma pulsing tool 106. The hydraulic fluid pumping unit 102 includes one or more fluid pumps that can pump hydraulic fracturing fluid to a downhole location (for example, through coiled tubing 104 or production tubing 104) in a wellbore 101 formed in a hydrocarbon reservoir 100. A hydraulic fracture 108 is to be initiated at the downhole location. The pumping unit 102 can flow the fluid to the downhole location at a hydraulic fluid pressure that is sufficient to initiate and propagate the hydraulic fracture 108 from the downhole location into the hydrocarbon reservoir 100.

In general, the hydraulic fluid pressure can be greater than the formation pressure of the reservoir 100 at the downhole location, and can be sufficient to initiate and propagate the fracture. In implementations in which the formation pressure is high (for example, about 7000 psi), the plasma pulsing tool 106 can be implemented to further increase the hydraulic fracturing pressure applied at the downhole location. The plasma pulsing tool 106 is positioned at the downhole location. The plasma pulsing tool 106 can generate and transmit a plasma pulse to the downhole location. The plasma pulse can increase the hydraulic fluid pressure of the fracturing fluid. The increased hydraulic fluid pressure can propagate the fracture to greater depths in the reservoir 100.

In some implementations, a power source (positioned at the surface 103 or downhole in the wellbore 101) is used to power the plasma pulsing tool 106. The plasma pulsing tool 106 generates and releases pulsed power, that is, electrical energy stored in capacitor banks. By varying inductances of a discharge system in the tool 106, energies ranging from 1 kiloJoules to 100 kiloJoules can be released over a pulse period ranging between 1 to 100 microseconds. The plasma pulsing tool 106 can be constructed to withstand a formation pressure at the downhole location (for example, a pressure of at least 10,000 pounds per square inch (psi)). In operation, the plasma pulsing tool 106 can be operated to generate multiple pulses at a frequency. Each pulse can be transmitted to the downhole location, for example, using the hydraulic fracturing fluid as the carrier.

The plasma generated by the tool 106 can act as a pressure intensifier for the hydraulic fluid pressure supplied by the pumping unit 102. That is, when the tool 106 is not pulsing, the hydraulic fluid pressure is applied to the downhole location by the hydraulic fracturing fluid. When the tool 106 pulses, the hydraulic fluid pressure increases to a value that is greater than the hydraulic fluid pressure alone. The increase is rapid, that is, the hydraulic fluid pressure increases quickly over time in response to receiving a pulse from the tool 106. In other words, the pressure increase caused by the plasma tool is a spike-like effect helping the fracturing operation and extending the fracturing fluid further into the formation. The increase in pressure increase a fracture force at the downhole location or increases a depth by which the fracture 108 propagates through the formation 100 (or both). For example, if a depth of fracture propagation in response to the hydraulic fracture fluid pressure alone is D1 and a depth of fracture propagation in response to the plasma pulse alone is D2, then a combined depth of fracture propagation in response to the increased hydraulic fluid pressure is at least D1+D2.

In some implementations, a notching tool (not shown) can be implemented at the downhole location to form a notch at the downhole location. The notch can decrease the stresses at the downhole location, thereby facilitating fracture formation and propagation.

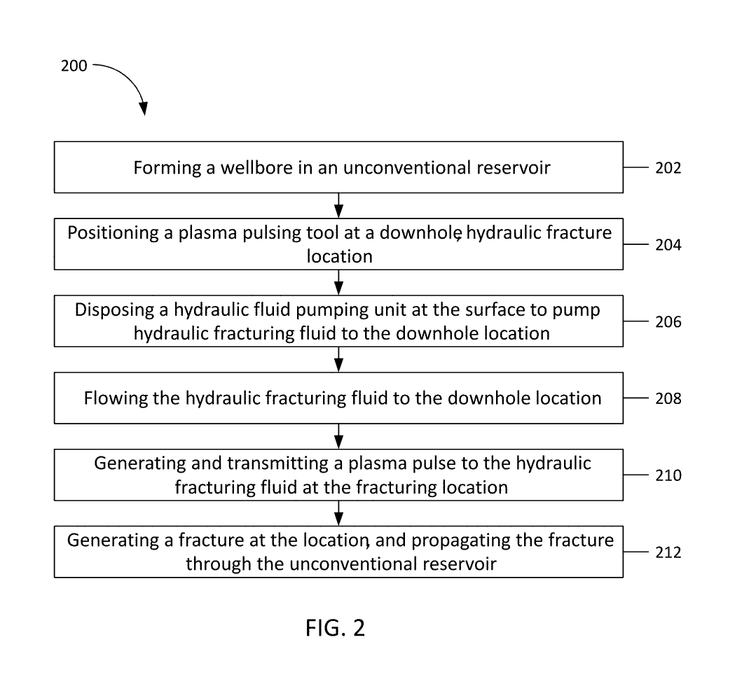

FIG. 2 is a flowchart of an example of a process 200 for hydraulic fracturing of a hydrocarbon reservoir. At least some portions of the process 200 can be implemented using the hydraulic fluid pumping unit 102 and the plasma pulsing tool 106 described earlier. At 202, a wellbore is formed in a reservoir, for example, an unconventional reservoir. The wellbore can include a horizontal wellbore. At 204, a plasma pulsing tool (for example, the plasma pulsing tool 106 (FIG. 1)) can be positioned at a downhole, hydraulic fracture location. At 206, a hydraulic fluid pumping unit (for example, the pumping unit 102 (FIG. 1)) can be used to pump hydraulic fracturing fluid to the downhole location. At 208, hydraulic fracturing fluid can be flowed to the downhole location.

At 210, a plasma pulse can be generated and transmitted to the downhole location. For example, the plasma pulse can be transmitted to the hydraulic fracture fluid that can transmit the pulse to the downhole location. As described earlier, the plasma pulsing tool can generate multiple pulses at a frequency, for example, one every 1 millisecond to 100 milliseconds. Each pulse can be transmitted to the hydraulic fluid, thereby increasing a pressure of the hydraulic fluid. The increased pressure can be transmitted and applied to the downhole location. In this manner, the plasma pulsing and the pumping unit can be operated at the same time to apply a combination of the hydraulic fluid pressure and the pressure of the plasma pulse to the downhole location. At 212, a fracture is generated at the location and propagates through the unconventional reservoir. A pressure applied at the location to overcome the formation pressure is greater than the hydraulic fluid pressure alone or the pressure of the plasma pulse alone.

The techniques described in this disclosure can be implemented to generate one or more fractures in wellbores of any orientation, for example, vertical wellbores, slanted wellbores or horizontal wellbores. In some implementations, a single plasma pulsing tool can be used to generate multiple fractures. Alternatively, or in addition, multiple plasma tools can be used, each to generate one respective fracture.

Any hydraulic fluid can be used in the implementations described in this disclosure. In some implementations, the hydraulic fluid can be a carbonaceous slurry-like fluid. The slurry-like fracturing fluid includes slurry water and a particulate portion. The particulate portion includes a calcium carbonate component, a cement component, a sand component, and a solid acid component. In some implementations, the particulate portion also includes a bentonite component.

The calcium carbonate component can be from naturally occurring sources or it can be man-made. Naturally occurring sources of calcium carbonate include rocks, shells of marine organisms, shells of snails, eggshells, and agricultural lime. In some implementations, the calcium carbonate is about 20-80% wt. of the particulate portion of the slurry-like fracturing fluid. In some implementations, the calcium carbonate is about 30-70% wt. of the particulate portion of the slurry-like fracturing fluid. In some implementations, the calcium carbonate is about 30-50% wt. of the particulate portion of the slurry-like fracturing fluid. In some implementations, the calcium carbonate is about 25-35% wt. of the particulate portion of the slurry-like fracturing fluid. In some implementations, the calcium carbonate component is about 30% wt. of the particulate portion. In some implementations, the calcium carbonate component is about 35% wt. of the particulate portion. In some implementations, the calcium carbonate component is about 40% wt. of the particulate portion. In some implementations, the calcium carbonate component is about 45% wt. of the particulate portion. In some implementations, the calcium carbonate component is about 50% wt. of the particulate portion. In some implementations, the calcium carbonate component is about 55% wt. of the particulate portion. In some implementations, the calcium carbonate component is about 60% wt. of the particulate portion. In some implementations, the calcium carbonate component is about 65% wt. of the particulate portion. In some implementations, the calcium carbonate component is about 70% wt. of the particulate portion. In some implementations, the calcium carbonate component is about 75% wt. of the particulate portion. In some implementations, the calcium carbonate component is about 80% wt. of the particulate portion.

The cement component is a binder that is capable of setting and hardening. In some implementations, the cement component is a hydraulic cement. In further implementations, the hydraulic cement is a Portland cement. In some implementations, the cement component is about 5-30% wt. of the particulate portion of the slurry-like fracturing fluid. In some implementations, the cement component is about 10-30% wt. of the particulate portion of the slurry-like fracturing fluid. In some implementations, the cement component is about 15-30% wt. of the particulate portion of the slurry-like fracturing fluid. In some implementations, the cement component is about 20-30% wt. of the particulate portion of the slurry-like fracturing fluid. In some implementations, the cement component is about 5% wt. of the particulate portion. In some implementations, the cement component is about 10% wt. of the particulate portion. In some implementations, the cement component is about 15% wt. of the particulate portion. In some implementations, the cement component is about 20% wt. of the particulate portion. In some implementations, the cement component is about 25% wt. of the particulate portion.

The sand component is a naturally occurring granular material that is made of fine rock and mineral particles. The composition of the sand component can vary widely depending on the source of the sand, as sand composition varies depending on the rock sources and conditions of the region from which it was obtained. In some implementations, the sand component includes silica based sands. In some implementations, the sand component will include a mixture of silica based sands. The particle sizes of the sand component can be fine (for example, having a mesh size of about 100 mesh), medium (for example, having a mesh size of about 40-70 mesh), or coarse (for example, having a mesh size of about 20-40 mesh). In some implementations, the sand component includes a wide range of particle sizes (for example, from fine particles to coarse particles). In some implementations, the sand component includes a narrow range of particle sizes (for example, from fine particles to medium particles or from medium particles to coarse particles). The sand component is bound in the permeable bed. In some implementations, the sand component is about 5-30% wt. of the particulate portion of the slurry-like fracturing fluid. In some implementations, the sand component is about 10-25% wt. of the particulate portion of the slurry-like fracturing fluid. In some implementations, the sand component is about 10-20% wt. of the particulate portion of the slurry-like fracturing fluid. In some implementations, the sand component is about 5% wt. of the particulate portion. In some implementations, the sand component is about 10% wt. of the particulate portion. In some implementations, the sand component is about 15% wt. of the particulate portion. In some implementations, the sand component is about 20% wt. of the particulate portion. In some implementations, the sand component is about 25% wt. of the particulate portion. In some implementations, the sand component is about 30% wt. of the particulate portion.

In further implementations, the sand component is replaced with other types of particulate material. Other types of particulate materials that can be used in some implementations include bauxite, carbalite, chalk, sea shells, coal, to name a few.

In some implementations, the particulate portion also includes a bentonite component. The bentonite component is an impure clay made mostly of montmorillonite. The bentonite component can include potassium bentonite, sodium bentonite, calcium bentonite, and aluminum bentonite. In some implementations, the bentonite component includes a mixture of bentonites. The amount of bentonite used can be adjusted in order to achieve a viscosity of the composition such that the viscosity is appropriate for the pumping of the fracturing fluid. In some implementations, the bentonite component is about 2-10% wt. of the particulate portion of the slurry-like fracturing fluid. In some implementations, the bentonite component is about 4-10% wt. of the particulate portion of the slurry-like fracturing fluid. In some implementations, the bentonite component is about 6-10% wt. of the particulate portion of the slurry-like fracturing fluid. In some implementations, the bentonite component is about 8-10% wt. of the particulate portion of the slurry-like fracturing fluid. In some implementations, the bentonite component is about 2% wt. of the particulate portion. In some implementations, the bentonite component is about 3% wt. of the particulate portion. In some implementations, the bentonite component is about 4% wt. of the particulate portion. In some implementations, the bentonite component is about 5% wt. of the particulate portion. In some implementations, the bentonite component is about 6% wt. of the particulate portion. In some implementations, the bentonite component is about 7% wt. of the particulate portion. In some implementations, the bentonite component is about 8% wt. of the particulate portion. In some implementations, the bentonite component is about 9% wt. of the particulate portion. In some implementations, the bentonite component is about 10% wt. of the particulate portion.

The solid acid component is any acid that is inert until it is triggered by reaching a temperature to begin hydrolyzing with a water source. Generally, the solid acids are temperature activated acids. In at least one implementation, the solid acid component is selected so that the triggering temperature is a resting reservoir temperature (that is, the reservoir temperature after the cooling effect of the injected cooler fluids have been neutralized). However, any acid that will become active after the slurry-like fracturing fluid is cured is an acceptable acid. In some implementations, the solid acids include sulfamic acid, chloroacetic acid, carboxylic acid, and trichloroacetic acid. As the solid acid becomes liquid acid it will stimulate the cured slurry-like fracturing fluid, thus making it more permeable for the gas and making the created fractures conductive. In some implementations, the solid acid component is about 5-30% wt. of the particulate portion of the slurry-like fracturing fluid. In some implementations, the solid acid component is about 5-10% wt. of the particulate portion of the slurry-like fracturing fluid. In some implementations, the solid acid component is about 10-15% wt. of the particulate portion of the slurry-like fracturing fluid. In some implementations, the solid acid component is about 15-20% wt. of the particulate portion of the slurry-like fracturing fluid. In some implementations, the solid acid component is about 20-25% wt. of the particulate portion of the slurry-like fracturing fluid. In some implementations, the solid acid component is about 25-30% wt. of the particulate portion of the slurry-like fracturing fluid. In some implementations, the solid acid component is about 5% wt. of the particulate portion. In some implementations, the solid acid component is about 10% wt. of the particulate portion. In some implementations, the solid acid component is about 15% wt. of the particulate portion. In some implementations, the solid acid component is about 20% wt. of the particulate portion. In some implementations, the solid acid component is about 25% wt. of the particulate portion. In some implementations, the solid acid component is about 30% wt. of the particulate portion.

Slurry water is added to the particulate portion to make the slurry-like fracturing fluid. The slurry water adjusts the viscosity of the slurry-like fracturing fluid. The amount of slurry water added can vary depending on the required viscosity of the resulting slurry-like fracturing fluid. In general, the viscosity of the slurry-like fracturing fluid should be such that it can be pumped to an unconventional reservoir during actual field treatment to fracture the unconventional reservoir. In some implementations, the slurry water is provided in the form of a brine. In further implementations, the slurry water is provided in the form of a brine that includes salts such as potassium chloride, sodium chloride, and calcium chloride. In further implementations, the slurry water is provided in the form of a salt solution. In further implementations, the salt solution is a potassium chloride solution, sodium chloride solution, or calcium chloride solution.

The slurry-like fracturing fluid can further include encapsulated components, degradable components, and gaseous materials. Among the encapsulated components include an encapsulated acid, such that its action is delayed until its encapsulating coating is dissociated. Gaseous materials could include nitrogen or carbon dioxide that could be used to create slurry foam compositions that increase the permeability of the slurry-like fracturing fluid as it cures.

A method of using the slurry-like fracturing fluid for hydraulic fracturing in an unconventional reservoir is provided. Example unconventional reservoirs include tight sand, shale gas, tight carbonate, coalbed methane, shale oil, and gas hydrate reservoirs. In at least one implementation, the unconventional reservoir is a tight sand reservoir. In at least one implementation, the unconventional reservoir is a shale reservoir. In at least one implementation, the unconventional reservoir is a sandstone formation. The reservoir temperature of the unconventional reservoir is at a resting reservoir temperature prior to the introduction of the slurry-like fracturing fluid to the unconventional reservoir. In at least one implementation, the resting reservoir temperature is greater than about 100° C. (212° F.). In at least one implementation, the resting reservoir temperature is greater than about 111° C. (231.8° F.), and no greater than about 150° C.

The slurry-like fracturing fluid, including the particulate portion and the slurry water as described here, is injected into the unconventional reservoir. In at least one implementation, the slurry-like fracturing fluid is injected in a horizontal well. Injecting the slurry-like fracturing fluid generates a network of fractures in the unconventional reservoir. The network of fractures extends from the well into the unconventional reservoir. In at least one implementation, injecting the slurry-like fracturing fluid causes a decrease in the reservoir temperature from the resting reservoir temperature to a reduced temperature.

The slurry-like fracturing fluid fills the network of fractures in the unconventional reservoir. The slurry-like fracturing fluid is then permitted to cure into a permeable bed in the network of fractures. In at least one implementation, the permeable bed is a solid porous carbonaceous bed filling the network of fractures in the unconventional reservoir. While the slurry-like fracturing fluid cures into the permeable bed, the reservoir temperature increases from the reduced temperature to the resting reservoir temperature. The slurry-like fracturing fluid becomes solid-like as it dehydrates. The solid acid in the slurry eventually hydrolyzes and creates permeability within the bed. The permeability of this bed is larger than that of the reservoir, for example, about 100 mD. The reservoir temperature returns to the resting reservoir temperature triggering the hydrolysis of the solid acid with a water source. Example sources useful as the water source include the slurry water present in the slurry-like fracturing fluid and formation brine present in the unconventional reservoir. The solid acid hydrolyzes with the water source to produce a liquid acid, including liquid-like acids.

The liquid acid etches the permeable bed. The liquid acid etching increases the permeability of the permeable bed in the network of fractures in the unconventional reservoir. In at least one implementation, the liquid acid etching effect creates small vugs in the permeable bed and makes it more permeable to the formation fluids, creating sweet spots (that is, a target location or area within a reservoir that represents the best production or potential production) around the stimulated well. The increased permeability stimulates the network of fractures in the unconventional reservoir. The stimulated network of fractures results in an increase in the flow of gases from the unconventional reservoir to the network of fractures and the well.

In some implementations, the slurry-like hydraulic fracturing fluids provide an alternative to conventional hydraulic fracturing for unconventional gas wells. The slurry-like fracturing fluid is used to fracture the unconventional gas formation instead of the conventional fracturing fluid and is left to cure within the induced fractures to become a permeable bed in the network of fractures. As this permeable bed attains the resting reservoir temperature, the solid acid in the permeable bed starts hydrolyzing with the water source. As the solid acid hydrolyzes and becomes liquid acid, it provides additional permeability to the reservoir by becoming a stimulating fluid within the permeable bed. The hydrolyzed, or liquid, acid starts etching the permeable bed filling the induced fractures, making the permeable bed conductive. The fractures in the reservoir which are filled with the slurry-like hydraulic fracturing fluids become permeable, thus allowing for commercial production from these unconventional gas wells. The use of a slurry-like fracturing fluid yields a network of permeable beds in a network of fractures bringing gas production to the well.

The materials used in the present disclosure can be mixed in relevant proportions in the field for use in the slurry-like hydraulic fracturing fluids. The slurry-like hydraulic fracturing fluids can be pumped with higher pressure than the formation fracturing gradient, similar to traditional fracturing fluids.

In some implementations, implementations of the present disclosure will reduce costs of hydraulic fracturing by eliminating the need to use expensive materials such as proppant, gel, gelling agents, cross linkers, and gel breakers. In some implementations, implementations of the present disclosure will eliminate formation damage within a reservoir that is usually caused by fracturing gel. In further implementations, implementations of the present disclosure eliminates problems related to proppant crushing, gel stability, formation damage, and lengthy cleanup procedures experienced with traditional fracturing fluids.

### EXAMPLES

### Example 1

A laboratory simulation has been conducted using a slurry-like fracturing fluid according to an embodiment of the disclosure. A slurry-like fracturing fluid was prepared using 30 grams (g) of calcium carbonate, 25 g of Portland cement, 20 g of solid acid (carboxylic acid), 15 g sand, and 10 g of bentonite. To this was added a sufficient amount of water (for example, 50% water by weight) as the slurry water to create the slurry-like fracturing fluid. The slurry-like fracturing fluid was cast in a plug and loaded in core flooding rigs. Reservoir level stress of 2000 psi was applied on the sample, along with an upstream pressure of 1000 psi and downstream pressure (back pressure) of 500 psi. The plug sample's permeability was measured at increasing temperatures from room to reservoir conditions at 111° C. (231° F.).

Permeability was measured according to the equation shown in Table 1.

TABLE 1
Steady State Permeability Analysis: K(mD) = (C × Q × m × L)/(DP × A)

| | |
|---|---|
| K (milliDarcy, mD) | Permeability |
| C | 245 (constant for psi to mega-Pascal (mpa)) |
| Q | Flow rate (cc/min) |
| m | Viscosity (centipoise) |
| L | Sample length (cm) |
| DP | Pressure (psi) difference between upstream |
| | and downstream |
| A | Area (square, centimeter, sq. cm) |
| Injection Fluid | NaCl (10% of total weight) |

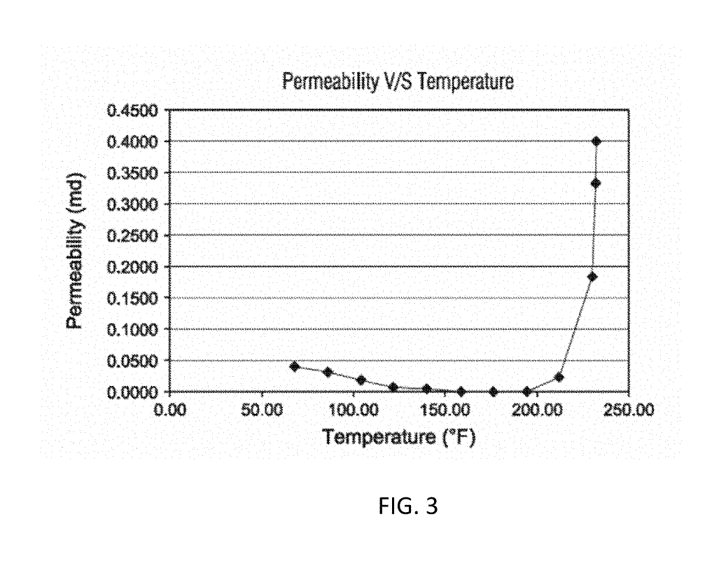

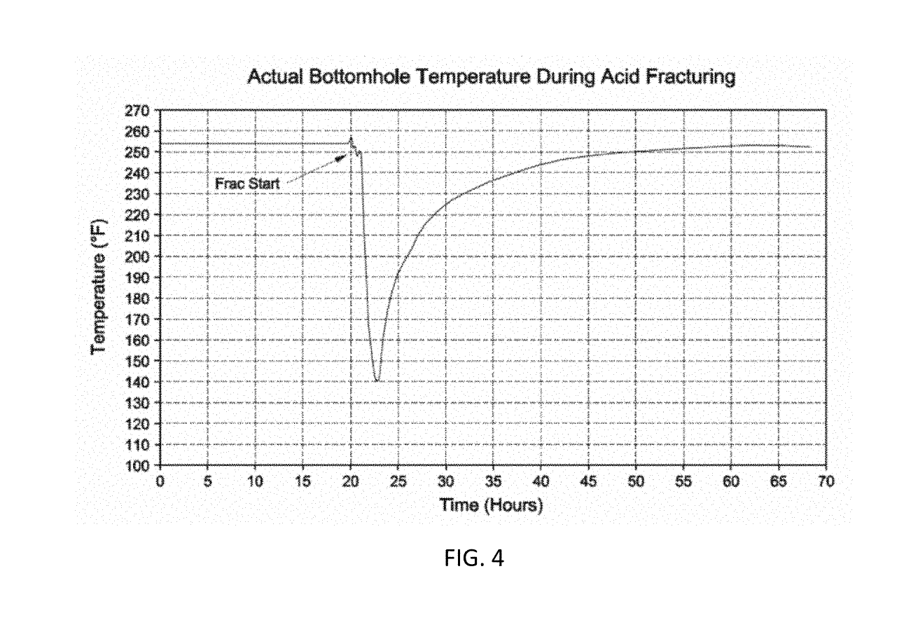

The permeability results are shown in in FIG. 3. As can be seen in FIG. 3, permeability increased from less than 0.05 mD at room temperature to about 0.4 mD after the temperature reached 111° C. (231° F.). It should be noted that reservoir temperature during hydraulic fracturing will not be reached instantly by the fracturing fluid; rather, temperature progressively increases in the system back to the resting reservoir temperature. This progressive temperature increase was measured in a stimulation treatment as shown in FIG. 4. As shown in FIG. 4, the actual bottomhole temperature remained substantially constant over time until fracture started. Upon initiation of fracture, the bottomhole temperature dropped rapidly (for example, from between 250-260° F. to about 140-150° F. in less than 5 hours). The bottomhole temperature increased and returned to the bottomhole temperature prior to initiation of fracture in about 20 hours.

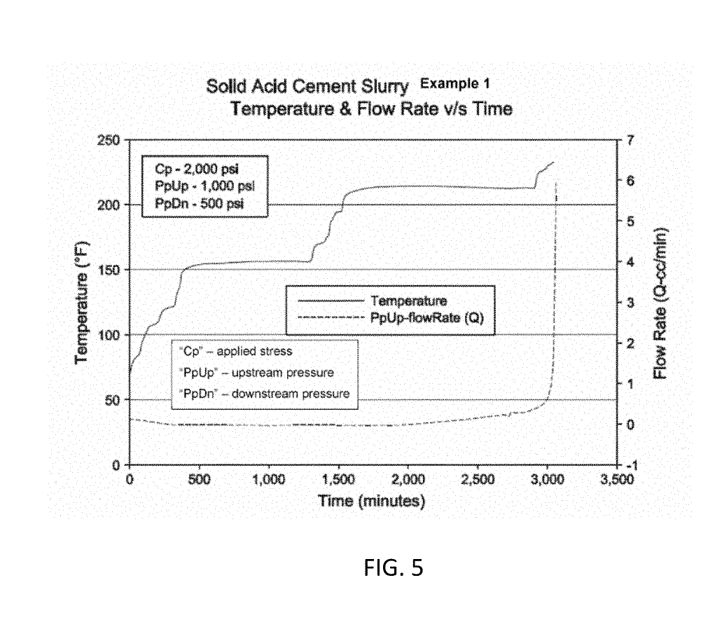

During the experiment of permeability measurement, the temperature of the sample was gradually increased to reach the reservoir temperature of 111° C. FIG. 5 shows the temperature profile with the flow rate going through the solid sample of the slurry-like fracturing fluid sample. This analysis confirmed that flow increased sharply through the sample when the temperature of 111° C. was reached, confirming that hydrolysis of the acid occurred in situ and that permeability of the sample improved rapidly at this temperature.

The experimental conditions were monitored over time at certain temperatures. At these temperatures, the flow rate, viscosity, and permeability of the slurry-like fracturing fluid were analyzed. The data are summarized in Table 2.

TABLE 2

| | Temp | | | | |
|---|---|---|---|---|---|
| | (degrees | Q-Flow | Differential | Viscosity | Per- |
| | centigrade, | Rate | Pressure DP | (centipoise, | meability |
| Step | ° C.) | (cc/min) | (microPascal) | cP) | (mD) |
| 1 | 20 | 0.16 | 1,042.10 | 1.0421 | 0.0394 |
| 2 | 30 | 0.16 | 833.10 | 0.8331 | 0.0315 |
| 3 | 40 | 0.11 | 685.70 | 0.6857 | 0.0184 |
| 4 | 50 | 0.05 | 576.7 | 0.5767 | 0.0066 |
| 5 | 60 | 0.04 | 493.90 | 0.4939 | 0.0043 |
| 6 | 70 | 0.02 | 429.30 | 0.4293 | 0.0018 |
| 7 | 80 | 0.01 | 377.80 | 0.3778 | 0.0012 |
| 8 | 90 | 0.01 | 336.00 | 0.3660 | 0.0007 |
| 9 | 100 | 0.32 | 301.6 | 0.3016 | 0.0235 |
| 10 | 110 | 2.76 | 272.90 | 0.2729 | 0.1836 |
| 11 | 111 | 5.00 | 272.90 | 0.2729 | 0.3326 |
| 12 | 111 | 5.96 | 272.90 | 0.2729 | 0.3965 |

### Example 2

A laboratory simulation was also conducted using a slurry-like fracturing fluid, as in Example 1. A second slurry-like fracturing fluid was prepared using 40 g of calcium carbonate, 25 g of Portland cement, 20 g of solid acid (carboxylic acid), and 15 g sand. To this was added a sufficient amount of water (for example, 50% water by weight) to create the slurry-like fracturing fluid. The slurry-like fracturing fluid was cast in a plug and loaded in core flooding rigs. Reservoir level stress was applied. The applied stress on the sample was 2000 psi, along with an upstream pressure of 1000 psi and downstream pressure (back pressure) of 500 psi. The plug sample's permeability was measured at increasing temperatures from room to reservoir conditions at 111° C. (231° F.). Permeability was measured according to the equation shown in Table 1. The results are shown in Table 3.

| | | Differential | | |
|---|---|---|---|---|
| | Q-Flow Rate | Pressure DP | Viscosity | Permeability |
| Temp (° C.) | (cc/min) | (microPascal) | (cP) | (mD) |
| 20 | 0.060 | 1042.1 | 1.0421 | 0.00647 |
| 30 | 0.100 | 833.5 | 0.8335 | 0.00862 |
| 40 | 0.125 | 685.7 | 0.6857 | 0.00886 |
| 50 | 0.150 | 576.7 | 0.5767 | 0.00895 |
| 60 | 0.189 | 493.9 | 0.4939 | 0.00965 |
| 70 | 0.223 | 429.3 | 0.4293 | 0.00990 |
| 80 | 0.253 | 377.8 | 0.3778 | 0.00988 |
| 90 | 0.276 | 336.0 | 0.3360 | 0.00959 |
| 100 | 0.309 | 301.6 | 0.3016 | 0.00964 |
| 110 | 0.341 | 272.9 | 0.2729 | 0.00962 |
| 120 | 0.392 | 248.9 | 0.2489 | 0.01009 |
| 20 | 0.107 | 1042.1 | 1.0421 | 0.01153 |
| 20 | 0.060 | 1042.1 | 1.0421 | 0.00647 |

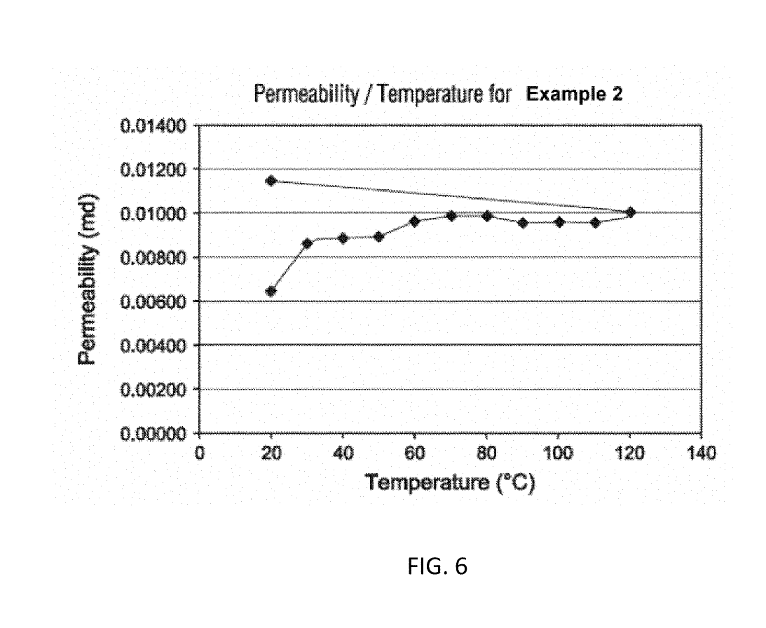

As shown in FIG. 6, the permeability improved as the temperature approached the reservoir temperature and the permeability improvement continued, confirming that the stimulation was due to solid acid hydrolyzing and stimulating the cured slurry bed. The experiment examined the permeability of the solidified slurry fluid with temperature. The start of the temperature is the temperature of the fluid as it is injected into the reservoir. With time, the temperature equalizes with that of the reservoir temperature. The solid acid then hydrolyzes and stimulates the solidified slurry bed, increasing its permeability. As the temperature rises back to near-room temperature, the permeability did not decrease in value, indicating that there has been a permanent improvement in permeability confirming that the increase was due to the solid acid which stimulated the packed fracture when the solid acid hydrolyzed.

Thus, particular implementations of the subject matter have been described. Other implementations are within the scope of the following claims.

1. A hydraulic fracturing system comprising:
a hydraulic fluid pumping unit configured to pump hydraulic fracturing fluid to a downhole location in a wellbore formed in a hydrocarbon reservoir at which a hydraulic fracture is to be initiated at a hydraulic fluid pressure sufficient to initiate and propagate the hydraulic fracture from the downhole location into the hydrocarbon reservoir; and
a plasma pulsing tool positioned at the downhole location, the plasma pulsing tool configured to generate and transmit a plasma pulse to the downhole location, the plasma pulse configured to increase the hydraulic fluid pressure of the hydraulic fracturing fluid.

2. The system of claim 1, further comprising coiled tubing configured to transport the plasma pulsing tool from a surface of the wellbore to the downhole location.

3. The system of claim 2, further comprising a power source connected to the plasma pulsing tool, the power source configured to provide power to the plasma pulsing tool in response to which the plasma pulsing tool generates the plasma pulse.

4. The system of claim 1, wherein the plasma pulsing tool is configured to generate plasma pulses having energies ranging between 1 kiloJoule (kJ) and 10 kJ.

5. The system of claim 1, wherein the plasma pulsing tool is configured to generate plasma pulses having energies greater than 10 kJ.

6. The system of claim 1, wherein the plasma pulsing tool is configured to withstand a formation pressure of at least 10,000 psi.

7. The system of claim 1, further comprising a notching tool configured to form a notch at the downhole location.

8. The system of claim 1, wherein the wellbore comprises a horizontal wellbore.

9. The system of claim 1, wherein the hydraulic fracturing fluid comprises a particulate portion and a water portion, the water portion operable to adjust a viscosity of the hydraulic fracturing fluid, such that the hydraulic fracturing fluid is capable of being pumped into the unconventional reservoir and the hydraulic fracturing fluid is capable of fracturing the unconventional reservoir.

10. The system of claim 9, wherein the particulate portion comprises:
a calcium carbonate component;
a cement component;
a sand component;
a bentonite component; and
a solid acid component.

11. The system of claim 10, wherein the calcium carbonate component is obtained from a naturally occurring source.

12. The system of claim 10, wherein the cement component is Portland cement.

13. The system of claim 10, wherein the sand component is a silica based sand.

14. The system of claim 10, wherein the bentonite component is selected from the group consisting of potassium bentonite, sodium bentonite, calcium bentonite, aluminum bentonite, and combinations thereof.

15. The system of claim 10, wherein the solid acid component is selected from the group consisting of sulfamic acid, chloroacetic acid, carboxylic acid, trichloroacetic acid, and combinations thereof.

16. The system of claim 10, wherein the particulate portion is between 20-80% wt. calcium carbonate component, 5-30% wt. cement component, 5-30% wt. sand component, 2-10% wt. bentonite component, and 5-30% wt. solid acid component.

17. The system of claim 10, wherein the particulate portion is 30% wt. calcium carbonate component, 25% wt. cement component, 15% wt. sand component, 10% wt. bentonite component, and 20% wt. solid acid component.

18. The system of claim 1, wherein the hydrocarbon reservoir is an unconventional reservoir.

19. A hydraulic fracturing method comprising:
flowing hydraulic fracturing fluid to a downhole location in a wellbore formed in a hydrocarbon reservoir at a hydraulic fluid pressure sufficient to initiate and propagate a hydraulic fracture from the downhole location into the hydrocarbon reservoir;
while flowing the hydraulic fracturing fluid to the downhole location, generating a transmitting a plasma pulse to the downhole location in the wellbore, the plasma pulse increasing the hydraulic fluid pressure of the hydraulic fracturing fluid; and
generating and propagating the hydraulic fracture at the downhole location based on the increased hydraulic fluid pressure of the hydraulic fracturing fluid.

20. The method of claim 19, wherein the plasma pulse is generated and transmitted by a plasma pulsing tool, wherein the method further comprises positioning the plasma pulsing tool at the downhole location.

21. The method of claim 19, wherein the plasma pulse is a first plasma pulse, wherein the method further comprises generating a sequence of plasma pulses including the first plasma pulse, and transmitting each plasma pulse to the hydraulic fluid.

22. The method of claim 21, wherein the sequence of plasma pulses are transmitted to the hydraulic fluid at a frequency.

23. The method of claim 19, further comprising forming a notch at the downhole location before flowing the hydraulic fracturing fluid or generating and transmitting the plasma pulse.
